(19) United States
(12) Patent Application Publication
(10) Pub. No.: US 2003/0088435 A1
(43) Pub. Date: May 8, 2003

(54) Zip code savings

(76) Inventor: Sandra Ray King, Washington, DC (US)

Correspondence Address: Sandra Vernida Ray King-Garside, 816 Kennedy Street, NE, Washington, DC, 20011, US

(21) Appl. No.: 10/218,499

(22) Filed: Nov. 20, 2002

Related U.S. Application Data
(60) Provisional application No. 60/312,467, filed on Aug. 16, 2001.

(51) Int. Cl. G06F 17/60

(52) U.S. Cl. 705/1; 705/14

(57) ABSTRACT

This is a service with novel features which saves consumers money, time, and eliminates stress by telling them if a product they want to purchase is on sale, where it is on sale, and which of that store's locations is closest to them based on their zip code. This service includes mapping errands and appointments, as well a dining and entertainment planning and transport service with all activities located in close proximity to each other for savings. For instance, saving on gas, time, money, and not to mention less anxiety. The consumer will be transported to each activity and even picked up from work. No longer will consumers have to stand in a store wondering if any other store has the item on sale, if so, at a better price? Consumers can call the service on their cell phone or call on the nearest pay phone and check in the databank to see if the product is on sale in any other store, if so, at what price? No longer will consumers have to get panic trying to locate a sale's circular the last night of a sale because they want to be sure that if they wait until tomorrow to purchase an item when the new sale starts, they are not missing the item being on sale in this week's. By simply calling or logging onto the web the item can quickly be researched as to whether it was on sale for this week. The service helps the elderly and the visually impaired whom can't see the newspaper for sales. They can call the service and the researchers will assist them in providing them the price and store information on the products they're interested in purchasing for the week. Information that is given to the consumer to better assist in making their travel an easier one is when the search is completed it will give the following information for each store: the store hours, telephone number, address, directions to the store; detailed transportation information on bus, subway, taxi, or in automobile (based on the consumer's departure location)—Bus stop and transfer points; Subway line & cost, subway travel time; Taxi fare/zones (approx.); Automobile—traffic conditions/detours. Because one of the service's key features is its zip code tracking system it also instructs consumers which store location is closest to the consumer. The service also maps personal and professional errands and prescheduled appointments based on zip code for more savings in time and money.

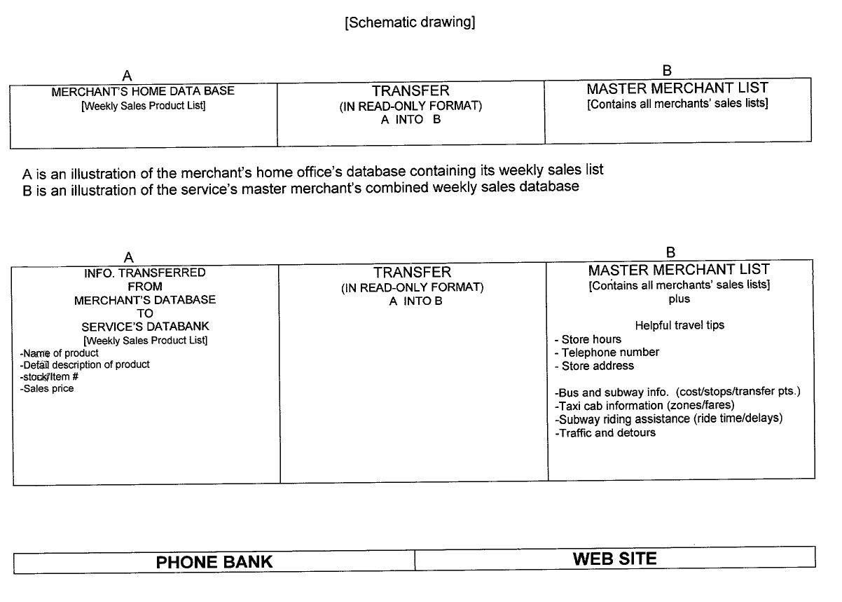

### BACKGROUND OF THE INVENTION

1. Field of Invention

This invention provides consumers savings based on zip code and relates to a service that reduces stress by eliminating the stress of flipping through myriads of weekly sales circulars to see if a product they want to purchase is on sale, and then determine which of these stores has the product at the lowest sales price, and which of that store's locations is closest to the consumer. This service manages a databank that contains merchant's weekly sales listings which is transferred to the service's databank by the merchant in read-only format to secure the prices and other details so that no one but someone at the merchant's home office can make changes or corrections to the sales data. Consumers have the choice of calling in and requesting a researcher do a quick search in the databank for a product they're interested in purchasing or the consumer can log onto the service's website and do a quick search in the same databank. Because one of the service's key features is its zip code tracking system it also instructs consumers which store location is closest to them. The service also maps personal and professional errands and prescheduled appointments based on zip code for savings in time and money. Also the Dining, Entertainment, and Transportation services that the service offers fully plans the whole evening, making reservations, providing transportation to each activity, and even picking consumers up from work.

2. Description of Prior Service

The conventional method of searching to see if a product we want to buy is on sale, as we know it today, has improved from black and white print to color print. However, neither of these paper form informational sources guarantee the consumer that since they've been provided all this sales information on all these stores they'll be 100% accurate in purchasing products at the store with the lowest sales prices. Although, most stores print their sales circulars with pictures of the products on sales for the week which are a great help in assisting the consumer in identifying the products on sale, there are some products that are printed without pictures and are advertised in text format only, which are easily overlooked because most of the times the text is very small and mixed in columns and rows with other text advertisements. This service's databank is 100% accurate because it is not physically searched or researched by anyone other than the staff at the merchant's home office. A copy of the weekly sales list is transferred to the service's master databank where all the merchant's sales lists are housed for that week. The merchants transfer a copy of their sales list to the service's databank in read-only format, which is a security measure that ensures the sales prices, product information, and other information about the items on sale can't be changed by anyone other than someone at the home office. When there is a correction or edit made at the home office it is automatically made in all of the services' computers and a message box comes up on all of the computers informing the researchers that there has been an “EDIT:” or “CORRECTION:” made. The sales databank is changed weekly. The same time the merchants give the newspaper distribution departments the word to release the sales circulars to the public, the merchants forward their sales list to the service's databank.

### Merchants

WalMart

Target

Ahold or Giant Food

Shopper Food Warehouse

Office Depot

Staples Office Supplies

### SUMMARY OF THE INVENTION

The primary object of the invention is to provide persons a service that tells them if a product they're looking to buy is on sale, which store has it on sale for the lowest price, and which one of that store's locations is closest to the consumer. When the search is completed it will give the following information for each store: the store hours, telephone number, address, directions to the store; Detailed transportation information on bus, subway, taxi, or automobile (based on the consumer's departure location); Bus stop and transfer points; Subway line & cost, subway travel time; Taxi fare/zones (approx.); Automobile—traffic conditions/detours. Also, based on zip code mapping errands and appointments and taking advantage of the dining, entertainment, and transportation service is also a big advantage to professionals and persons with busy schedules to take advantage of by allowing their entire day be mapped out for them—keeping in mind any prescheduled appointments and working around those times.

### BRIEF DESCRIPTION OF SERVICE METHOD

### DETAILED DESCRIPTION OF THE METHOD

Referring in detail to the schematic, in FIG. A, merchants forward their weekly product sales list that's to be advertised and on sale for that week in read-only format to the service's master databank FIG. B. FIG. B shows the master merchant sales databank, which contains every member-merchant's sales lists on products that are on sale that week. The service's databank is accessible to its phone bank operators to assist those consumers whom call in for products to be researched and its also available to those consumers who log onto the service's website to conduct the product locator search themselves. In addition, FIG. B shows some helpful travel tips the service offers the consumers when they contact the service either by telephone or when logging onto their website which will help making travel to the merchant less stressful.

1. A method of saving the public money by reducing their travel time comprising:
a) a computer databank of current weekly retail sales advertisements
b) said databank consisting of local merchants, whose store's location appears on the computer monitor as closest to the consumer calling in looking for a store closest to them based on zip code, and
c) providing transportation, travel, and weather conditions, and
d) mapping errands and appointments in a most direct route
